(19) United States
(12) Patent Application Publication
(10) Pub. No.: US 2022/0117286 A1
(43) Pub. Date: Apr. 21, 2022

(54) PECAN NUT KERNEL EXTRACTION METHOD

(71) Applicant: Christoper Laurence Dunshea, Nelspruit (ZA)

(72) Inventors: Anthony Walter Berlein, White River (ZA); Mary Catherine Berlein, Nelspruit (ZA)

(21) Appl. No.: 17/431,237

(22) PCT Filed: Oct. 9, 2019
(86) PCT No.: PCT/IB2019/058608

§ 371 Date: Aug. 16, 2021

(30) Foreign Application Priority Data
Feb. 18, 2019 (ZA) 2019/01009

(51) Int. Cl. A23N 5/00

(52) U.S. Cl. CPC A23N 5/00

(57) ABSTRACT

The invention relates to a pecan nut kernel extraction method including the steps of sizing pecan nuts from which kernels are to be extracted to have a maximum diameter size variation of 8 mm; controlling the moisture content of the shells of the pecan nuts to within a shell moisture control range of 3% to 30%; heating the kernels to a temperature of between 20° C. and 100° C.; pre-cracking the shells; immersing the nuts in liquid nitrogen, or the like, for between 5 and 15 seconds; and cracking the shells within no more than 15 seconds from completing the cryogenic fluid immersion step to substantially separate the shells from the kernels. The method also includes performing the steps in the absence of a pre-cracking step or in the absence of the cryogenic fluid immersion step.

### FIELD OF THE INVENTION

This invention relates to a method for extracting pecan (Carya illinoensis) kernels from their shells.

### BACKGROUND TO THE INVENTION

There are a number of plant families which produce fruits protected by shells and which are fit for human consumption, and typically cultivated for that purpose. One of these is the pecan tree (Carya illinoensis).

Pecans have fruits (i.e. the kernel) contained within shells, and these shells are difficult to crack and their kernels difficult to extract intact.

The primary objective for cracking the shells is to substantially break the shell in order to obtain as high a percentage possible of intact and unblemished kernels, free from contamination of foreign material and shell residue.

Prior art systems and methods are typically highly inefficient in respect of this objective. The inefficiencies firstly result in the generation of a high percentage of broken kernels (i.e. smaller than a half-kernel). This lowers the value of the final product, where currently the differential in price between intact halves and pieces/particles and dust is almost $2 US per pound on average, which is significant to a pecan processor. Secondly, the milling (i.e. processing) losses are substantial, and can be as high as 13%. Such losses are incurred when inefficient cracking methods are used which generate fine pieces that cannot be recovered or alternatively where kernels remain struck in their shells and require expensive manual labour to extract it or have to be discarded (as is mostly the case).

Methods which attempt to extract pecan nut kernels with brute force from their shells are bound to fail, or be very inefficient, since the shell of the pecan nut is very effective in protecting the kernel. The level of brute force that is required to break the shell of a pecan nut is typically so much that in the process the kernel is also damaged. Current pecan nut product requirements are such that it rewards processes that produce the least possible defects or missing parts of the kernel, and punish those that don't meet these requirements. Brute force methods are not well suited for this and are not well rewarded for the quality of pecan nut products they can produce.

There have been some refinements in the approach to pecan nut kernel extraction, notably through the general process of U.S. Pat. No. 6,224,932 (“Stahmann”) which amongst other foodstuffs also relates to tree nuts. Stahmann discloses a method and apparatus that uses cryogenic Theological modification of shelled foods' (tree nuts, molluscs, and crustaceans). Stahmann recognises that freezing shelled foods with cryogenics will have the expected result of embrittling the shells of the shelled foods.

Stahmann notes that the fracturing of the frozen shell of a shelled food may occur with less force than would otherwise be required, which at the time appeared to be a step in the right direction considering the above-mentioned issues with the brute force approach. Any reduction in the force required to break a shell of a shelled food, including tree nuts, would normally be expected to yield improved results.

Stahmann thus proposed a three-step process, which includes hydration, cryogenic freezing, and fracturing.

In respect of tree nuts specifically, Stahmann states that the nuts should be hydrated and then briefly be exposed to a cryogenic fluid. The hydration appears to have had a dual purpose for Stahmann, in that firstly it provides moisture into the shell which make it more susceptible to freezing on contact with a cryogenic fluid and which aids in fracturing the shell. Secondly, Stahmann also believed that he could add moisture to the kernel, which he did in an attempt to protect the nutmeat (i.e. the kernel). Specifically, Stahmann aimed to hydrate the kernel of a nut to a moisture content of between 5% and 7%.

Stahmann states that with the hydration step the “free” water content of the nutmeat (kernel) increases which makes the nutmeat pliable and renders it immune to shattering when the shell is fractured or cracked. Stahmann states that when liquid nitrogen is used as a cryogenic fluid, the shell temperature will drop to −320° F. and becomes very brittle, but the nutmeat (kernel) remains pliable (on his theory due to the increased moisture content and the relative protection to the kernel resulting from the Leidenfrost effect). Stahmann reports improved results, but notably his results still show some broken pieces and milling losses.

The inventor of the present invention considered the approach followed by Stahmann, and notes that Stahmann does not recognise the effectiveness of the pecan shell to act as a barrier in protecting the kernel, both physically and chemically. The purpose of the pecan shell is to buffer the kernel against fluctuating environmental changes that may occur outside it, and the shell is rather good at this. These fluctuations include variations in humidity and temperature. The shell functions to limit the movement of especially moisture into and out of the interior of the shell, which enables the kernel to remain at steady moisture level. If the kernel is distressed the shell will allow moisture in faster to replenish it, but once it reaches its normal level the buffering effect of the shell becomes applicable again.

Hydration tests conducted by the inventor indicate that even with a significant amount of forced hydration time (about 15 minutes of high temperature steaming), the average moisture content of pecan nut kernels measured only about 3.75%, which represents almost no increase in moisture of the kernel. If nuts with obvious damage, such as cracks, are excluded from the results, then the average moisture content is only about 3.1%. Notably, only the nuts with obvious damage fall in the 5% to 7% range that Stahmann prescribes. The results of this control test is shown in Table 1.

This supports the theory that a pecan nut's shell is very effective in protecting its kernel and regulating the flow of moisture into the kernel.

Attempts to hydrate undamaged pecans nut under practical and economically viable conditions do not seem to have any notable effect on the moisture content of the kernel and appear ineffective in notably increasing the moisture content of the kernel. It may be possible to produce an increase in kernel moisture if the nuts were soaked for several days, but this introduces an increase in processing time which is not acceptable. Even then, it is still questionable whether such increase in moisture content in the kernel is desirable.

As mentioned above, it appears only the moisture content of damaged nuts increased notably with hydration. This is not surprising since the cracks that constitute the damage provide clear pathways for moisture to penetrate to the interior of the nut, i.e. to reach the kernel. Essentially, the shell cannot fully perform its protective role when it is damaged.

This is problematic, since damaged nuts usually result in discolouration on the kernels (due to exposure to the atmosphere) and higher risk of contamination with pathogens.

Additionally, where the moisture content of a damaged nut is increased due to hydration, the same cracks that allowed the moisture to reach the kernel will also allow a cryogenic fluid to reach the kernel. This will increase the possibility that such a kernel could be embrittled by the cryogen, which would be exacerbated by the higher moisture content of such a kernel. This goes against Stahmann's teaching that increasing the moisture content of the kernel makes it more pliable. To the contrary, it actually puts kernels contained in damaged nuts at greater risk from the fracturing process. There is typically a relevant percentage of damage nuts present during processing unless they are sorted out—which would still leave them to be treated separately, facing the same problem.

Therefore, if by means of hydration techniques with much longer exposure times the kernel moisture content is increased, such kernels will be exposed to the risk of discolouration and degradation, and also an increased risk of fracturing when the shell is cracked after cryogenic treatment.

In general, Stahmann's results are not repeatable in practical conditions and on an economical scale with undamaged pecan nuts. It is also notable that the Stahmann process does not appear to have met with commercial acceptance, despite the fact that it dates back by more than 20 years.

It does appear that Stahmann was partly misdirected. Although he achieved better results than the prior art brute force techniques, this may possibly be attributed to being able to apply about 10% less force than what was used in prior art brute force techniques. The improvement that Stahmann achieved was probably only due to the use of cryogenics, which achieved the expected result of embrittling the shell of the pecan nut. Stahmann teaches that the moisture content of the kernel has to be increased to make it more pliable, but as the applicant has found this is not practically possible with undamaged nuts, and actually exposes the kernel to greater risk of fracturing when the nuts are treated with cryogenics. The inability of Stahmann's process to efficiently handle damaged nuts likely detracted from the overall success of his process.

There is a need for a process that at least partly overcomes the abovementioned problems.

In this specification the following terms have the associated meanings:
“USDA Standard” means the United States Standards for Grades of Shelled Pecans no 83 FR 50475, dated 10 Dec. 2018, issued by the US Department of Agriculture;
The term “half-kernel” means one of the separated halves of an entire pecan kernel with not more than one-eighth of its original volume missing, exclusive of the portion which formerly connected the two halves of the kernel, as per the USDA Standard;
The term “piece” means a portion of a kernel which is less than seven-eighths of a half-kernel, but which will not pass through a round opening two-sixteenths inch in diameter, as per the USDA Standard;
The term “particles and dust” means for all size designations except “extra small pieces” and “granules,” fragments of kernels which will pass through a round opening two-sixteenths inch in diameter, as per the USDA Standard.
The term “pre-cracking” means the step of partial cracking of the shell of a pecan nut in which one or more cracks may form in the shell substantially without the shell separating from the kernel, and with the shell remaining substantially intact over the kernel even if small pieces of shell separate from the bulk of the shell and even if some of the cracks propagate through the shell and the atmosphere inside the shell surrounding the kernel has been exposed to the environmental atmosphere; and
The term “pre-cracked” means a pecan nut of which the shell has been subjected to pre-cracking, whether actively, accidentally through handling during the harvesting, cleaning or sizing of the pecans, or passively as a result of natural causes.

### Objective of the Invention

It is an objective of the invention to provide an improved method for extracting pecan nut kernels from their shells which at least partly overcomes the abovementioned problem.

### SUMMARY OF THE INVENTION

In accordance with this invention there is provided a pecan nut kernel extraction method including the steps of—
a. sizing pecan nuts from which kernels are to be extracted to have a maximum diameter size variation of 8 mm;
b. controlling the moisture content of the shells of the pecan nuts to within a shell moisture control range of 3% to 30%;
c. heating the kernels to a temperature of between 20° C. and 100° C.;
d. pre-cracking the shells;
e. immersing the nuts in liquid nitrogen, or the like, for between 5 and 15 seconds; and
f. cracking the shells within no more than 15 seconds from completing step e) to substantially separate the shells from the kernels.

There is further provided for the immersion time period in step e) to preferably be 10 seconds.

According to a further aspect of the invention there is provided a pecan nut kernel extraction method which includes the steps of—
a. sizing pecan nuts from which kernels are to be extracted to have a maximum diameter size variation of 8 mm;
b. controlling the moisture content of the shells of the pecan nuts to within a shell moisture control range of 3% to 30%;
c. heating the kernels to a temperature of between 20° C. and 100° C.;
d. immersing the nuts in liquid nitrogen or a similar medium or environment, for a predetermined time period between 15 and 30 seconds; and
e. cracking the shells within no more than 15 seconds from completing step d) to substantially separate the shells from the kernels.

There is further provided for the method to include the step of cleaning the pecan nuts before immersing them in liquid nitrogen.

According to a yet further aspect of the invention there is provided a pecan nut kernel extraction method which includes the steps of—
a. sizing pecan nuts from which kernels are to be extracted to have a maximum diameter size variation of 8 mm;
b. controlling the moisture content of the shells of the pecan nuts to within a shell moisture control range of 3% to 30%;
c. heating the kernels to a temperature of between 20° C. and 100° C.;
d. pre-cracking the shells;
e. allowing the nut shells to cool down to a temperature of about 20° C.; and
f. cracking the shells to substantially separate the shells from the kernels.

There is further provided for the method to include the step of cleaning the pecan nuts before heating the kernels.

There is further provided for the kernels to be heated to a temperature of about 70° C., and for the heating to include exposing the pecan nuts to a minimum temperature of 70° C. for at least 2 minutes.

There is also provided for the kernels to be heated by subjecting the nuts to an amount of microwave radiation for a predetermined time period, the combination of the amount of microwave radiation and the time period which has been empirically determined to heat the kernels of a specific pecan cultivar from which kernels are being extracted using the method to the desired temperature.

There is also provided for the step of controlling the moisture content of the shells of the pecan nuts to include empirically determining the moisture content of the shells, and subjecting the pecan nuts to remedial action to either increase or decrease the moisture content of the shells to be within the shell moisture control range, and preferably for the remedial action for increasing the moisture content of the shells to comprise any one or more of subjecting the pecan nuts to steaming or boiling, or by humidifying the shells.

There is further provided for the pecan nuts to be subjected to steaming for a period of between 1 and 20 minutes, preferably a period of between 3 and 15 minutes, and most preferably a period of between 5 and 12 minutes.

There is also provided for the remedial action for decreasing the moisture content of the shells to comprise actively or passively drying the shells.

There is still further provided for the shell moisture control range to preferably be between about 5% and 20%.

There is further provided for the step of heating the kernels to comprise subjecting the pecan nuts to steaming or boiling, and preferably for the method to include subjecting the pecan nuts to steaming or boiling to simultaneously achieve the remedial action of increasing the moisture content of the shells and to heat the kernels.

There is still further provided for the step of heating the kernels to comprise subjecting the pecan nuts to a heating step that excludes the addition of moisture, including subjecting the pecan nuts to microwave heating or convection heating, and if required subjecting the pecan nuts to a separate pasteurisation step.

There is also provided for the remedial action of decreasing the moisture content of the shells to include subjecting the pecan nuts to active or passive drying of their shells.

According a still further aspect of the invention there is provided a pecan nut kernel extraction method including the steps of—
a. sizing pecan nuts, at least some of which have been pre-cracked and from which kernels are to be extracted, to have a maximum diameter size variation of 8 mm;
b. controlling the moisture content of the shells of the pecan nuts to within a shell moisture control range of 3% to 30%;
c. heating the kernels to a temperature of between 20° C. and 100° C.;
d. immersing the nuts in liquid nitrogen, or the like, for between 5 and 15 seconds; and
e. cracking the shells within no more than 15 seconds from completing step d) to substantially separate the shells from the kernels.

There is further provided for the kernels to be heated to a temperature of about 70° C., and for the heating to include exposing the pecan nuts to a minimum temperature of 70° C. for at least 2 minutes.

There is further provided for the step of controlling the moisture content of the shells of the pecan nuts to include empirically determining the moisture content of the shells, and subjecting the nuts to remedial action to either increase or decrease the moisture content of the shells to be within the shell moisture control range, preferably for the remedial action for increasing the moisture content of the shells to comprise any one or more of subjecting the pecan nuts to steaming or boiling, or by humidifying the shells, and more preferably for the pecan nuts to be subjected to steaming for a period of between 2.5 and 10 minutes, and still more preferably for a period of about 5 minutes.

There is further provided for the remedial action for decreasing the moisture content of the shells to comprise actively or passively drying the shells.

There is also provided for the pre-cracking of the shells to comprise subjecting them to mechanical stress, preferably in a mechanical cracker configured to deliver only side impacts to the nuts.

There is still further provided for the pecan nuts to be sized preferably to have a variation in diameter not exceeding 6 mm, more preferably not exceeding 4 mm, and still more preferably to have a variation in diameter between 1 mm and 3 mm, and most preferably to have a variation in diameter of about 1.5 mm.

There is also provided for the method to include the step of splitting any whole kernels produced by the method.

These and other features of the invention are described in more detail below.

### BRIEF DESCRIPTION OF THE DRAWINGS

Preferred embodiments of the invention are described by way of example only and with reference to the drawings in which:

Table 1 shows the effect of steaming pecan nuts on its kernel moisture content, with an average starting moisture content of about 3%;

FIG. 1 is a diagrammatic representation of the process flow used in example 1;

FIG. 2 is a diagrammatic representation of the process flow used in example 2;

FIG. 3 is a diagrammatic representation of the process flow used in example 3;

FIG. 4A is a diagrammatic representation of the process flow used in example 4A; and

FIG. 4B is a diagrammatic representation of the process flow used in example 4B.

### DETAILED DESCRIPTION OF THE INVENTION

The applicant has found that it is possible to use the characteristics of the shell to assist in the recovery of the kernel from the shell without damaging the kernel. The applicant aims to disrupt the structure of the shell as much as possible, without removing it from around the kernel, prior to exposing it to a cryogen. This is done in concert with increasing the temperature of the kernel, which protects the kernel from the process of destructing the shell.

It is required to strike a balance between compromising the shell and breaking the shell. If the shell is largely detached there is a risk of discolouration and exposure of the kernel to the cryogenic fluid.

The inventor therefore recognized that it is inevitable that at least some nuts will have their kernels exposed to the cryogenic fluid and has found that the risk of damage to such nuts especially, but also other undamaged nuts in general, can be managed by heating the kernels.

The effect of heating the kernels is believed to decrease the viscosity of oils and fats within the kernel, which makes the kernel more pliable and resistant to impact forces. This is also believed to protect the kernel against the possible effects of freezing. In terms of the kernel, the temperature differential between the heated kernel and any cryogen that may penetrate through a cracked shell will accentuate the Leidenfrost effect. This at least creates a time delay between the cryogen coming into contact with the kernel and the kernel freezing as a result of it. In addition, the cryogen then still has to extract the heat from the kernel before the kernel will freeze.

In contrast, the shell has much less fats and oils, and with an increase in its moisture content to within the shell moisture control range, the shell will be targeted much quicker by the cryogen than the kernel will be when the pecan nuts are immersed in the cryogen. Another factor here is that with pre-cracking the cryogen is enabled to contact the shell on the outside and also on the inside (between the shell and the kernel). The shell is thinner than the kernel and at least to some extent contacted by the cryogen from both outside and inside. In comparison, the kernel is thicker and only contacted to a limited extent on its outer surface by the cryogen, to the extent that it penetrates the cracks in the shell caused by the pre-cracking. This amplifies the time difference that it takes the cryogen to freeze the shell compared to freezing the kernel.

This allows in practical terms a time delay between exposure to the cryogen and possible freezing of the kernel. By managing the heat in the kernel, i.e. its temperature, and the duration of exposure to the cryogen the risk of fracturing the kernel is effectively addressed.

The inventor has established that the best results are obtained when the nuts are compromised before exposure to the cryogenic fluid and the kernel are heated. However, it is possible to achieve still acceptable results, which also present an improvement over the results from prior art techniques, by making use of either comprising the shells before exposure to cryogenic fluid or heating the kernels.

The inventor has established that there are several possible implementations of this principle, some of which is explained in more detail with reference to test results below. In each instance, practical variables are accounted for to compensate for characteristics of specific pecan cultivars that are being treated.

### Example 1—Mixed Cultivar (Nuts which are not Pre-Cracked)

Mixed cultivar pecans in-shell (1), with a medium kernel content of about 51% (shell to kernel ratio), and with a kernel moisture content of less than 4% and a shell moisture content of between 8% and 10%, were pre-sized (2) into a size range of 22 mm to 24 mm.

The nuts in shell were then boiled (3) for 10 minutes. As a result of this, the kernel moisture content of the nuts increased to between 4% and 5%, and the shell moisture content of the nuts increased to about 20%.

The nuts were allowed to cool (4) for 5 minutes. The nuts were then exposed to liquid nitrogen (5) for 20 seconds and cracked in a double jaw-type cracker (6) with a total taper from top to bottom of 2.5 mm in less than 5 seconds following completion of the exposure to the liquid nitrogen.

This resulted in a recovery of 100% fully intact kernels with 100% cracked and shelled after cracking (7).

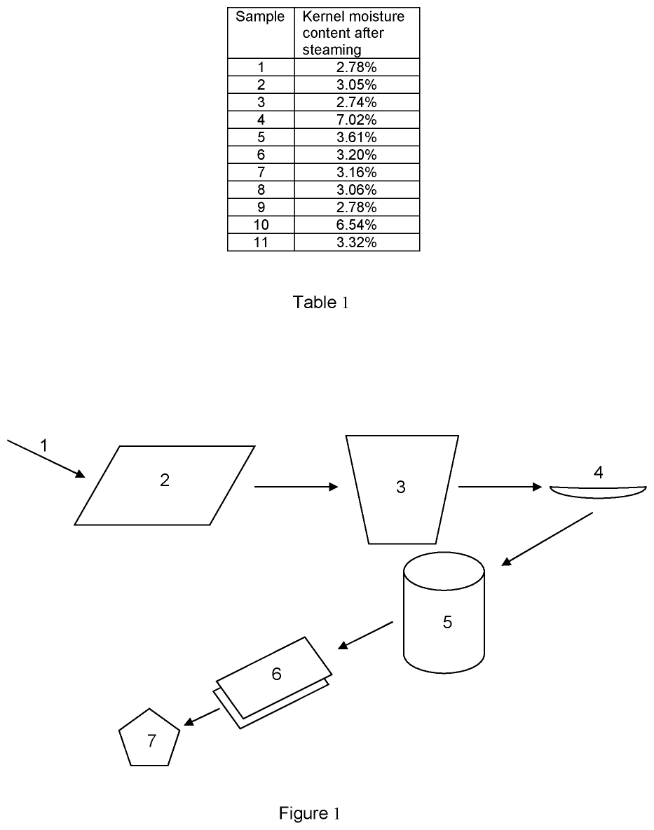

The process flow of this example is indicated graphically in FIG. 1.

### Example 2—Mixed Cultivar (Pre-Cracked and Pre-Sized Nuts)

Pre-cracked mixed cultivar pecans in-shell (11), with a medium kernel content of about 51% (shell to kernel ratio), and with a kernel moisture content of about 3% and a shell moisture content of between 8% and 10%, were pre-sized (12) into a size range of 24 mm to 26 mm.

The nuts in shell were steamed (13) at atmospheric pressure at about 98° C. for 5 minutes.

The nuts were allowed to cool (14) for 2% minutes. The nuts were then exposed to liquid nitrogen (15) for 10 seconds and cracked in a double jaw-type cracker (16) with a total taper from top to bottom of 6 mm in less than 5 seconds following completion of the exposure to the liquid nitrogen.

This resulted in a recovery of 100% fully intact kernels with 100% cracked and shelled after cracking (17).

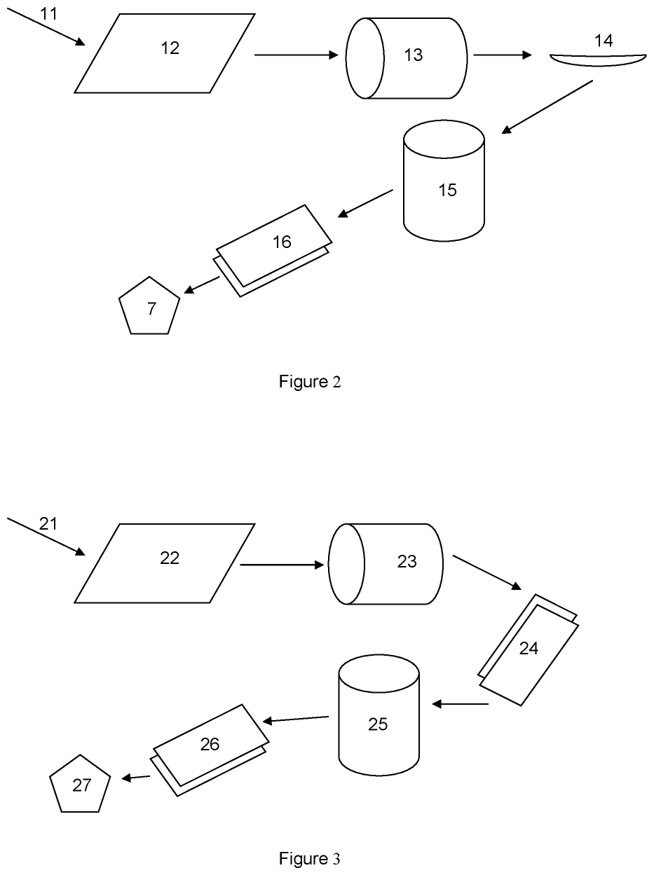

The process flow of this example is indicated graphically in FIG. 2.

### Example 3—Ukulinga Cultivar

Thick shell cultivar (Ukulinga) pecans in-shell (which are notoriously difficult to crack due to their thick shells) (21), with a medium kernel content of about 50% (shell to kernel ratio), and with a kernel moisture content of about 3% and a shell moisture content of between 8% and 10%, were pre-sized (22) into a size range of 20 mm to 21.5 mm.

The nuts in shell were steamed (23) at atmospheric pressure at about 98° C. for 15 minutes.

Whilst still hot the nuts were pre-cracked (24) in a double jaw-type cracker with an initial total taper from top to bottom of 1 mm and the jaws in the maximum closed position of 20.5 mm at the inlet and 19.5 mm at the outlet.

The nuts were then exposed to liquid nitrogen (25) for 10 seconds, and in less than 5 seconds following completion of the exposure to the liquid nitrogen the nuts were cracked in the same double jaw-type cracker with a total taper from top to bottom of 1 mm (26). For the final cracking the jaws were closed by 2 mm, to have in the maximum closed position a size of 18.5 mm at the inlet and 17.5 mm at the outlet.

This resulted in a recovery of 95% fully intact kernels with 97% cracked and shelled after cracking (27).

The process flow of this example is indicated graphically in FIG. 3.

### Example 4—Wichita Cultivar (Comparison)

A comparison was made between the results of pre-cracking nuts and of not pre-cracking nuts, with subsequent cryogenic treatment of the nuts.

For the nuts treated without pre-cracking, Wichita cultivar with a shell to kernel ratio of 62% (31), which are notoriously difficult to crack due to their high kernel percentage without severe damage to the kernels, with a shell moisture content of 7% and kernel moisture content of about 3%, were pre-sized (32) in a size range of 21.5 mm to 23 mm.

The nuts in shell were steamed (33) at atmospheric pressure at about 98° C. for 15 minutes.

The shell-moisture content increased to about 11.5% and the kernel moisture content increased to about 4.5%.

The nuts were then exposed to liquid nitrogen (34) for 15 seconds, and in less than 5 seconds following completion of the exposure to the liquid nitrogen the nuts were cracked in a double jaw-type cracker with a total taper from top to bottom of 3 mm, with an inlet setting in the maximum closed position of 21.5 mm and 18.5 mm at the outlet (35).

This resulted in a recovery of 75% fully intact kernels with 35% cracked and shelled after cracking (36).

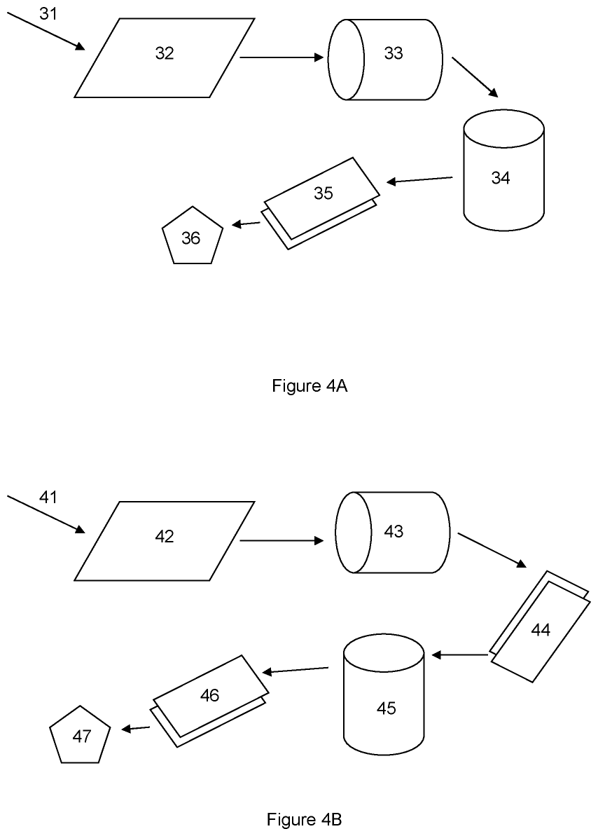

The process flow of this example is indicated graphically in FIG. 4A.

For the nuts treated with pre-cracking, a second sample was drawn from the same batch of Wichita cultivar with a shell to kernel ratio of 62% (41) with a shell moisture content of 7% and kernel moisture content of about 3%, were pre-sized (42) into a size range of 21.5 mm to 23 mm.

The nuts in shell were steamed (43) at atmospheric pressure at about 98° C. for 15 minutes.

The shell-moisture content increased to about 11.5% and the kernel moisture content increased to about 4.5%.

The nuts where then, within 10 seconds from the steaming, pre-cracked (44) in the same double-jaw cracker (as that described with reference to FIG. 4A) with an inlet setting of 21.5 mm and 18.5 mm at the outlet, for a total taper from top to bottom of 3 mm.

The nuts were then exposed to liquid nitrogen (45) for 10 seconds, and in less than 5 seconds following completion of the exposure to the liquid nitrogen the nuts were cracked (46) in the same double jaw-type cracker with an inlet setting in the maximum closed position of 20.5 mm and 17.5 mm at the outlet, for a total taper from top to bottom of 3 mm.

This resulted in a recovery of 81% fully intact kernels with 81% cracked and shelled after cracking (47).

The process flow of this example is indicated graphically in FIG. 4B.

With this comparison the effect of the combination of the pre-cracking and heating (in this instance by means of steaming) is shown. The typical recovery of Wichita cultivar with a shell to kernel ratio of about 62%, is less than 50% fully intact kernels with less than 10% cracked and shelled after cracking. The combination of pre-cracking and heating thus presents a significant improvement of prior art processes. Even the heating without pre-cracking presents a notable improvement over the prior art processes.

In cultivars that are easier to process, it is possible to achieve improved and acceptable results by using heating and/or pre-cracking with the liquid nitrogen.

By making use of the process of the invention it is possible to impact the nuts with a force that is greater than what is conventionally used to crack pecan nut shells. The advantage of this, contrary to conventional wisdom, is that such a greater and in effect sharper (higher impact) force, shatters the shell with greater effect than a lower level impact. Since the kernels are protected by their increased temperature, the higher force on the shell does not damage the kernel.

In respect of the kernel and shell, the level of oils and fats in the kernel is about 20 times greater than those in the shell. This explains why the kernel's resilience is more much responsive to an increase in temperature of the kernel, than the resilience of the shell is to the same increase in temperature—the shell contains far less oils and fats compared to the kernel. The high fat and oil content of the kernel allows these constituents to increase the pliability of the kernel when they are heated up, with a reduction in their viscosity. At higher temperature these oils and fats flow easier, which is believed to allow the kernel to resist impacts more successfully.

It will be appreciated that the embodiments described above are given by way of example only and are not intended to limit the scope of the invention.

1-29. (canceled)

30. A pecan nut kernel extraction method, comprising:
sizing pecan nuts from which kernels are to be extracted to have a maximum diameter size variation of 8 mm;
controlling the moisture content of shells of the pecan nuts to within a shell moisture control range of 3% to 30%;
heating the kernels to a temperature of between 20° C. and 100° C.;
pre-cracking the shells;
immersing the pecan nuts in liquid nitrogen for between 5 and 15 seconds; and
cracking the shells within no more than 15 seconds from completing the immersing step to substantially separate the shells from the kernels.

31. The pecan nut kernel extraction method of claim 30 wherein the immersion time period in the immersion step is 10 seconds.

32. A pecan nut kernel extraction method, comprising:
sizing pecan nuts from which kernels are to be extracted to have a maximum diameter size variation of 8 mm;
heating the kernels to a temperature of between 20° C. and 100° C.;
controlling the moisture content of shells of the pecan nuts to within a shell moisture control range of 3% to 30%;
immersing the pecan nuts in liquid nitrogen for a predetermined time period between 15 and 30 seconds; and
cracking the shells within no more than 15 seconds from completing the immersing step to substantially separate the shells from the kernels.

33. The pecan nut kernel extraction method of claim 32, further comprising cleaning the pecan nuts before immersing them in liquid nitrogen.

34. A pecan nut kernel extraction method, comprising:
sizing pecan nuts from which kernels are to be extracted to have a maximum diameter size variation of 8 mm;
heating the kernels to a temperature of between 20° C. and 100° C.;
controlling the moisture content of shells of the pecan nuts to within a shell moisture control range of 3% to 30%;
pre-cracking the shells;
allowing the nut shells to cool down to a temperature of about 20° C.; and
cracking the shells to substantially separate the shells from the kernels.

35. The pecan nut kernel extraction method of claim 34, further comprising cleaning the pecan nuts before heating the kernels.

36. The pecan nut kernel extraction method of claim 34, wherein heating the kernels includes heating the kernels to a temperature of about 70° C.

37. The pecan nut kernel extraction method 34 wherein heating the kernels includes heating the kernels by exposing the pecan nuts to a minimum temperature of 70° C. for at least 2 minutes.

38. The pecan nut kernel extraction method 34 wherein heating the kernels includes subjecting the nuts to an amount of microwave radiation for a predetermined time period, the combination of the amount of microwave radiation and the time period which has been empirically determined to heat the kernels of a specific pecan cultivar from which kernels are being extracted using the method to the desired temperature.

39. The pecan nut kernel extraction method 34 wherein controlling the moisture content of the shells of the pecan nuts includes empirically determining the moisture content of the shells, and subjecting the pecan nuts to remedial action to either increase or decrease the moisture content of the shells to be within the shell moisture control range.

40. The pecan nut kernel extraction method of claim 39 wherein the remedial action for increasing the moisture content of the shells includes any one or more of subjecting the pecan nuts to steaming or boiling, or by humidifying the shells.

41. The pecan nut kernel extraction method 40 wherein the pecan nuts are subjected to steaming for a period of between 1 and 20 minutes.

42. The pecan nut kernel extraction method of claim 39 wherein the remedial action for decreasing the moisture content of the shells includes actively or passively drying the shells.

43. The pecan nut kernel extraction method of claim 34 wherein the shell moisture control range is between about 5% and 20%.

44. The pecan nut kernel extraction method of claim 34 wherein heating the kernels includes subjecting the pecan nuts to steaming or boiling.

45. The pecan nut kernel extraction method of claim 44 wherein the pecan nuts are subjected to steaming or boiling to simultaneously achieve the remedial action of increasing the moisture content of the shells and to heat the kernels.

46. The pecan nut kernel extraction method of claim 34 wherein heating the kernels includes subjecting the pecan nuts to a heating step that excludes the addition of moisture, including subjecting the pecan nuts to microwave heating or convection heating, and if required subjecting the pecan nuts to a separate pasteurization step.

47. The pecan nut kernel extraction method of claim 46 wherein the remedial action of decreasing the moisture content of the shells includes subjecting the pecan nuts to active or passive drying of their shells.

48. A pecan nut kernel extraction method, comprising:
sizing pecan nuts, at least some of which have been pre-cracked and from which kernels are to be extracted, to have a maximum diameter size variation of 8 mm;
controlling the moisture content of the shells of the pecan nuts to within a shell moisture control range of 3% to 30%;
heating the kernels to a temperature of between 20° C. and 100° C.;
immersing the nuts in liquid nitrogen for between 5 and 15 seconds; and
cracking the shells within no more than 15 seconds from completing the immersing step to substantially separate the shells from the kernels.

49. The pecan nut kernel extraction method of claim 48 wherein heating the kernels includes heating the kernels to a temperature of about 70° C.

50. The pecan nut kernel extraction method of claim 49 wherein heating the kernels includes exposing the pecan nuts to a minimum temperature of 70° C. for at least 2 minutes.

51. The pecan nut kernel extraction method of claim 48 wherein controlling the moisture content of the shells of the pecan nuts includes empirically determining the moisture content of the shells, and subjecting the nuts to remedial actions to either increase or decrease the moisture content of the shells to be within the shell moisture control range.

52. The pecan nut kernel extraction method of claim 51 wherein the remedial action for increasing the moisture content of the shells comprises any one or more of subjecting the pecan nuts to steaming or boiling, by or humidifying the shells.

53. The pecan nut kernel extraction method of claim 52 wherein the pecan nuts are subjected to steaming for a period of between 2.5 and 10 minutes.

54. The pecan nut kernel extraction method of claim 51 wherein the remedial action for decreasing the moisture content of the shells includes actively or passively drying the shells.

55. The pecan nut kernel extraction method of claim 48 wherein pre-cracking of the shells includes subjecting the shells to mechanical stress in a mechanical cracker configured to deliver only side impacts to the pecan nuts.

56. The pecan nut kernel extraction method of claim 48 wherein the shell moisture control range is between about 5% and 20%.

57. The pecan nut kernel extraction method of claim 48 wherein the pecan nuts are sized to have a variation in diameter not exceeding 6 mm.

58. The pecan nut kernel extraction method of claim 48, further comprising splitting any whole kernels produced by the method.
